(19) United States
(12) Patent Application Publication
(10) Pub. No.: US 2024/0151090 A1
(43) Pub. Date: May 9, 2024

(54) DIAGNOSING DEVICE, DIAGNOSING METHOD, AND NON-TRANSITORY COMPUTER-READABLE MEDIUM STORING DIAGNOSING PROGRAM

(71) Applicant: NABTESCO CORPORATION, Tokyo (JP)

(72) Inventors: Joji IMAI, Tokyo (JP); Shigetaka KAGA, Tokyo (JP)

(21) Appl. No.: 18/499,891

(22) Filed: Nov. 1, 2023

(30) Foreign Application Priority Data
Nov. 8, 2022 (JP) 2022-178869

(51) Int. Cl. E05F 15/41

(52) U.S. Cl. CPC E05F 15/41; E05Y 2400/504

(57) ABSTRACT

A diagnosing device identifies a plugging operation period in which a plug door performs a plugging operation, the plug door having a guide roller attached thereto, the plug door being configured to perform an opening-closing operation and the plugging operation by allowing the guide roller to move along a guide rail; obtains drive information including a value representing at least one of a current value or a torque value of a drive unit, the drive unit being configured to drive the plug door; and diagnoses an abnormality in the guide roller or the guide rail based on the drive information observed during the identified plugging operation period.

### CROSS-REFERENCE TO RELATED APPLICATIONS

This application is based on and claims the benefit of priority from Japanese Patent Application Serial No. 2022-178869 (filed on Nov. 8, 2022), the contents of which are hereby incorporated by reference in their entirety.

### TECHNICAL FIELD

The present disclosure relates to a diagnosing device, a diagnosing method and a non-transitory computer-readable medium storing a diagnosing program.

### BACKGROUND

A plug door device disclosed in Japanese Patent Application Publication No. Hei10-169298 (“the '298 Publication”) includes a guide rail allowing a guide roller attached to a door panel to travel thereon. As the guide roller moves along the guide rail, the door panel performs an opening-closing operation and a plugging operation.

The plug door device disclosed in the '298 Publication cannot reveal malfunctions of the guide roller until the door panel fails to move. For this reason, it has been desired to diagnose an abnormality in the guide roller or guide rail.

### SUMMARY

An aspect provides a diagnosing device. The diagnosing device includes circuitry. The circuitry is configured to perform: identifying a plugging operation period in which a plug door performs a plugging operation, the plug door having a guide roller attached thereto, the plug door being configured to perform an opening-closing operation and the plugging operation by allowing the guide roller to move along a guide rail; obtaining drive information including a value representing at least one of a current value or a torque value of a drive unit, the drive unit being configured to drive the plug door; and diagnosing an abnormality in the guide roller or the guide rail based on the drive information observed during the identified plugging operation period.

Another aspect provides a diagnosing method. The diagnosing method includes: identifying, by circuitry, a plugging operation period in which a plug door performs a plugging operation, the plug door having a guide roller attached thereto, the plug door being configured to perform an opening-closing operation and the plugging operation by allowing the guide roller to move along a guide rail; obtaining, by the circuitry, drive information including a value representing at least one of a current value or a torque value of a drive unit, the drive unit being configured to drive the plug door; and diagnosing, by the circuitry, an abnormality in the guide roller or the guide rail based on the drive information observed during the identified plugging operation period.

A yet another aspect provides a non-transitory computer-readable medium storing a diagnosing program. When the diagnosing program is executed by circuitry, the circuitry performs: identifying a plugging operation period in which a plug door performs a plugging operation, the plug door having a guide roller attached thereto, the plug door being configured to perform an opening-closing operation and the plugging operation by allowing the guide roller to move along a guide rail; obtaining drive information including a value representing at least one of a current value or a torque value of a drive unit, the drive unit being configured to drive the plug door; and diagnosing an abnormality in the guide roller or the guide rail based on the drive information observed during the identified plugging operation period.

### BRIEF DESCRIPTION OF THE DRAWINGS

FIG. 1 is a perspective view schematically showing the configuration of a door opening-closing device.

FIG. 2 is a plan view showing a door fully closed by the door opening-closing device.

FIG. 3 is a plan view showing the door opening-closing device performing a plugging operation of the door.

FIG. 4 is a plan view showing the door opening-closing device performing a sliding operation of the door.

FIG. 5 is a plan view showing the door fully opened by the door opening-closing device.

FIG. 6 is a block diagram showing the configuration of a door control device including a diagnosing device.

FIG. 7 is a flowchart showing how the door control device makes a diagnosis.

FIG. 8 shows a graph (a) indicating the rotational speed of a drive unit observed while the door is opening and closing under a normal condition and a graph (b) showing the torque of the drive unit observed while the door is opening and closing under a normal condition.

FIG. 9 shows a graph (a) indicating the rotational speed of the drive unit observed while the door is opening and closing under an abnormal condition and a graph (b) showing the torque of the drive unit observed while the door is opening and closing under an abnormal condition.

### DESCRIPTION OF THE PREFERRED EMBODIMENTS

### First Embodiment

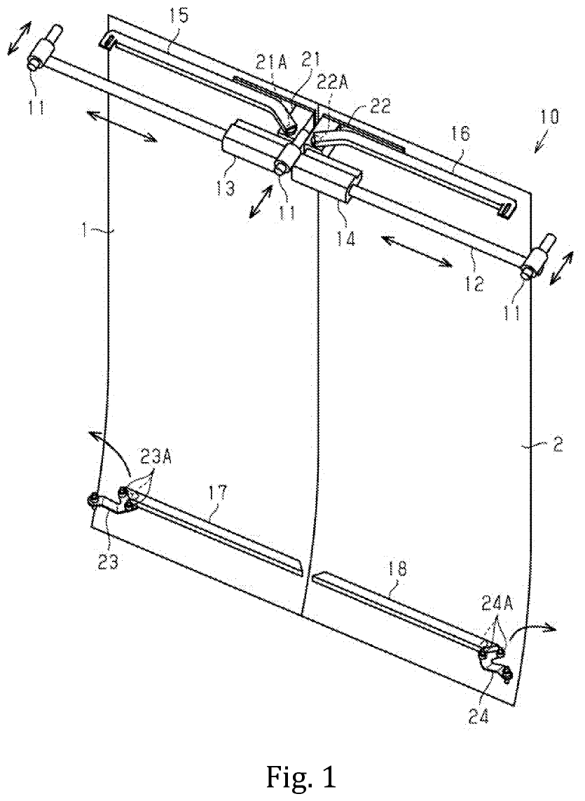

With reference to FIGS. 1 to 8, an embodiment of a door opening-closing device having a diagnosing device will be now described. The door opening-closing device is designed to open or close a door provided in a railroad car. The diagnosing device is included in a door control device for controlling the door opening-closing device.

As shown in FIG. 1, a first door leaf 1 and a second door leaf 2 constituting a double door are provided on a side surface of a car body of a railroad car. When opening or closing, the first and second door leaves 1 and 2 move in the front-rear direction of the railroad car and also in the width direction of the card body of the railroad car. Specifically, the first and second door leaves 1 and 2 are plug doors. The first and second door leaves 1 and 2 are positioned in the doorway of the car body and configured to move outwardly from the doorway of the car body and stay outside the car body when fully opened. A door opening-closing device 10 is provided inside the car body and above the doorway.

### Door Opening-Closing Device 10

The door opening-closing device 10 includes three plug rails 11 and one slide rail 12. The plug rails 11 extend in the width direction of the car body and fixedly attached to the car body. The slide rail 12 extends in the front-rear direction of the car body and is supported by the plug rails 11 in such a manner that it is movable in the width direction of the car body.

The door opening-closing device 10 includes a first guide rail 15, a second guide rail 16, a third guide rail 17, and a fourth guide rail 18. The first guide rail 15 extends in the front-rear direction of the car body. The end of the first guide rail 15 that is positioned near the middle of the doorway inclines toward the inside of the car body. The second guide rail 16 extends in the front-rear direction of the car body. The end of the second guide rail 16 that is positioned near the middle of the doorway inclines toward the inside of the car body. The first and second guide rails 15 and 16 are fixedly attached to the car body. The third guide rail 17 is fixedly attached to the lower portion of the surface of the first door leaf 1 facing the inside of the car body. The fourth guide rail 18 is fixedly attached to the lower portion of the surface of the second door leaf 2 facing the inside of the car body.

The slide rail 12 includes a first slider 13 and a second slider 14. The first and second sliders 13 and 14 are configured to move in the front-rear direction of the car body along the slide rail 12. The first slider 13 is connected to the first door leaf 1 via a first hanger 21. The first slider 13 is connected to a first end of the first hanger 21. A second end of the first hanger 21 is connected to the first door leaf 1. The second slider 14 is connected to the second door leaf 2 via a second hanger 22. The second slider 14 is connected to a first end of the second hanger 22. A second end of the second hanger 22 is connected to the second door leaf 2. The first hanger 21 has a first guide roller 21A. The first guide roller 21A is fitted in the first guide rail 15 and movable along the first guide rail 15. The second hanger 22 has a second guide roller 22A. The second guide roller 22A is fitted in the second guide rail 16 and movable along the second guide rail 16. The first and second sliders 13 and 14 can be driven by a drive unit (not shown) in the front-rear direction of the railroad car. The drive unit is a motor. The first and second hangers 21 and 22 each has a stopper (not shown) for, by abutting against the wall of the car body, keeping the first and second hangers 21 and 22 to stay at a fully opened position.

A first swing arm 23 is connected to the third guide rail 17 and configured to support the first door leaf 1. The first swing arm 23 can rotate as the first door leaf 1 performs a plugging operation. The first swing arm 23 has three third guide rollers 23A. The third guide rail 17 is sandwiched between (i) one of the third guide rollers 23A that is fitted in the third guide rail 17 and (ii) the remaining two third guide rollers 23A provided outside the third guide rail 17. The first door leaf 1 may move in the front-rear direction of the car body as the third guide rail 17 is supported by the third guide rollers 23A. A second swing arm 24 is connected to the fourth guide rail 18 and configured to support the second door leaf 2. The second swing arm 24 can rotate as the second door leaf 2 performs a plugging operation. The second swing arm 24 has three fourth guide rollers 24A. The fourth guide rail 18 is sandwiched between (i) one of the fourth guide rollers 24A that is fitted in the fourth guide rail 18 and (ii) the remaining two fourth guide rollers 24A provided outside the fourth guide rail 18. The second door leaf 2 may move in the front-rear direction of the car body as the fourth guide rail 18 is supported by the fourth guide rollers 24A.

### How Door Opening-Closing Device 10 Works

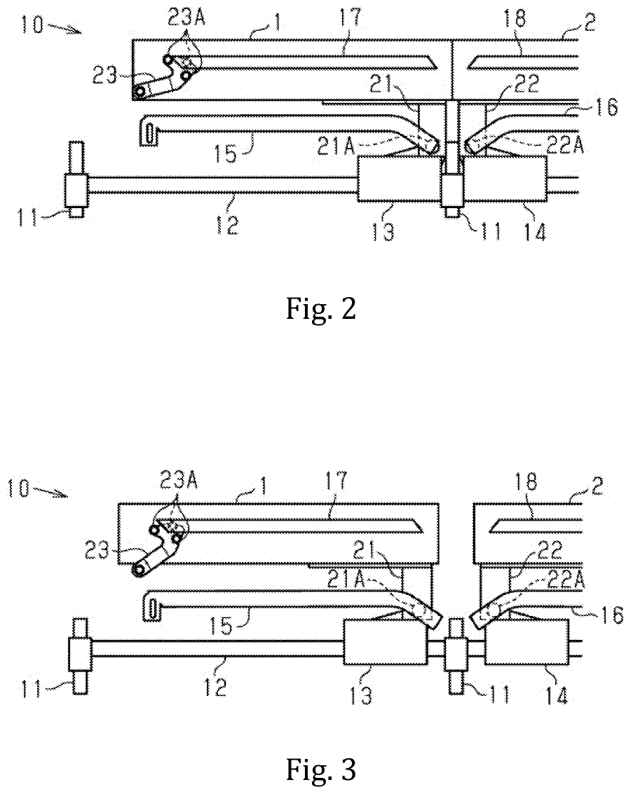

The following now describes how the door opening-closing device 10 works with reference to FIGS. 2 and 3.

As shown in FIG. 2, the first and second door leaves 1 and 2 are fully closed with the door ends of the first and second door leaves 1 and 2 being in touch with each other. The first guide roller 21A is positioned at the right end of the first guide rail 15. The second guide roller 22A is positioned at the left end of the second guide rail 16. The third guide rollers 23A are positioned at the left end of the third guide rail 17. The fourth guide rollers 24A are positioned at the right end of the fourth guide rail 18.

As shown in FIG. 3, the first and second door leaves 1 and 2 perform a plugging operation or move outward from the car body as the first and second sliders 13 and 14 start moving in an opening direction. The first guide roller 21A moves through the inclined portion of the first guide rail 15. The second guide roller 22A moves through the inclined portion of the second guide rail 16. The first swing arm 23 rotates anti-clockwise while the third guide rollers 23A remain positioned at the left end of the third guide rail 17. The second swing arm 24 rotates clockwise while the fourth guide rollers 24A remain positioned at the right end of the fourth guide rail 18.

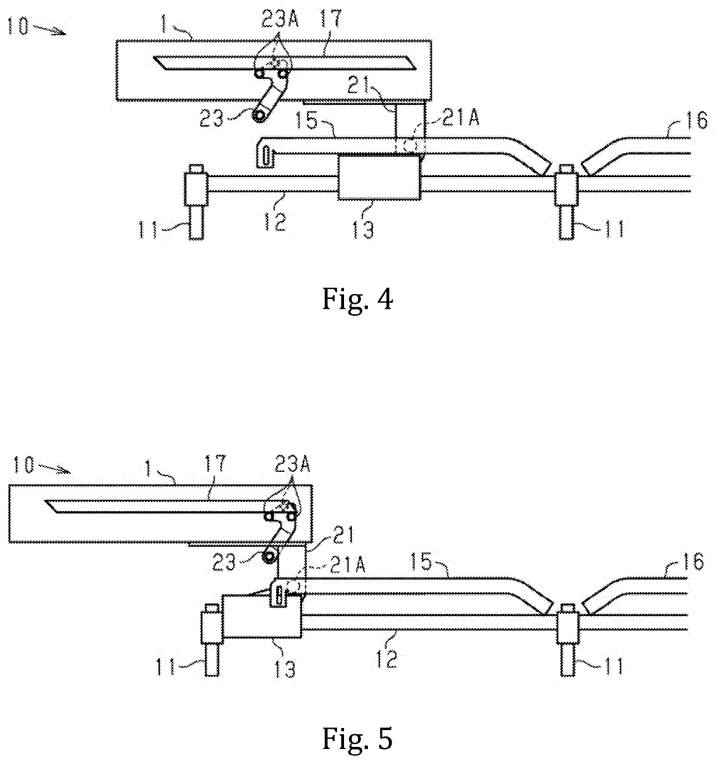

As shown in FIG. 4, the first and second door leaves 1 and 2 perform an opening operation or move in the front-rear direction of the car body as the first and second sliders 13 and 14 further move in the opening direction. The first guide roller 21A moves through an opening-closing portion of the first guide rail 15 that extends in the front-rear direction (the left-right direction in FIG. 4). The second guide roller 22A moves through an opening-closing portion of the second guide rail 16 that extends in the front-rear direction (the left-right direction in FIG. 4). While the first swing arm 23 remains stationary at the most distant position from the car body, the third guide rollers 23A move relative to and along the third guide rail 17. To be exact, the first door leaf 1 moves relative to the first swing arm 23. While the second swing arm 24 remains stationary at the most distant position from the car body, the fourth guide rollers 24A move relative to and along the fourth guide rail 18. To be exact, the second door leaf 2 moves relative to the second swing arm 24.

As shown in FIG. 5, the first and second door leaves 1 and 2 are fully opened or positioned most distantly from each other. The first guide roller 21A is positioned at the left end of the first guide rail 15. The second guide roller 22A is positioned at the right end of the second guide rail 16. While the first swing arm 23 remains stationary at the most distant position from the railroad car, the third guide rollers 23A are positioned at the right end of the third guide rail 17. While the second swing arm 24 remains stationary at the most distant position from the car body, the fourth guide rollers 24A are positioned at the left end of the fourth guide rail 18.

### Door Control Device 30

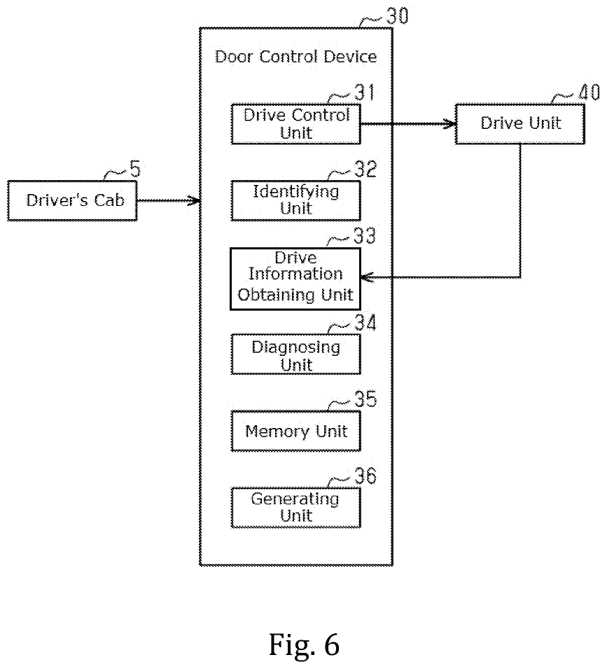

FIG. 6 is a block diagram showing the door control device 30 configured to control the door opening-closing device 10 configured to open or close the first and second door leaves 1 and 2. The door control device 30 is configured to drive and control a drive unit 40 in response to an opening-closing control instruction issued by a driver's cab 5, so that the first and second door leaves 1 and 2 are opened or closed. The drive unit 40 is an electric motor. The door control device 30 includes a diagnosing device configured to diagnose an abnormality in the guide rollers or guide rails. The procedures to be executed by the door control device 30 include a diagnosing method. The diagnosing method includes an identifying procedure, a drive information obtaining procedure and a diagnosing procedure, which will be described below. The door control device 30 may be formed as circuitry including: 1) one or more processors that perform various processes in accordance with a computer program (software); 2) one or more dedicated hardware circuits such as application-specific integrated circuits (ASICs) that perform at least a part of the various processes; or 3) a combination thereof. The processors include a CPU and a memory such as a RAM or a ROM. The memory stores program codes or instructions configured to cause the CPU to perform processes. The memory or a non-transitory computer-readable medium encompasses any kind of available media accessible via a general-purpose or dedicated computer. The programs stored in the computer-readable medium include a diagnosing program. The computer-readable medium causes the door control device 30 to execute the identifying procedure, drive information obtaining procedure, and diagnosing procedure when the door control device 30 executes the diagnosing program.

The door control device 30 includes a drive control unit 31, an identifying unit 32, a drive information obtaining unit 33, a diagnosing unit 34, a memory unit 35 and a generating unit 36. The drive control unit 31 controls the drive unit 40 based on an opening-closing control instruction issued by the driver's cab 5. The identifying unit 32 acquires opening-closing control information from the drive control unit 31. The opening-closing control information includes opening control information relating to a control designed to open the first and second door leaves 1 and 2 and closing control information relating to a control designed to close the first and second door leaves 1 and 2. The identifying unit 32 identifies, based on the acquired opening-closing control information, a plugging operation period in which the first and second door leaves 1 and 2 perform a plugging operation. The identifying unit 32 identifies the plugging operation period and opening-closing operation period based on the elapsed time from the time at which the opening-closing control starts, which is included in the opening-closing control information. The identifying unit 32 measures the elapsed time from the time at which the opening-closing control information is received. The drive control unit 31 calculates the traveled distance since the start of the rotation and controls the first and second door leaves 1 and 2 to stay stationary at a predetermined distance (opening distance).

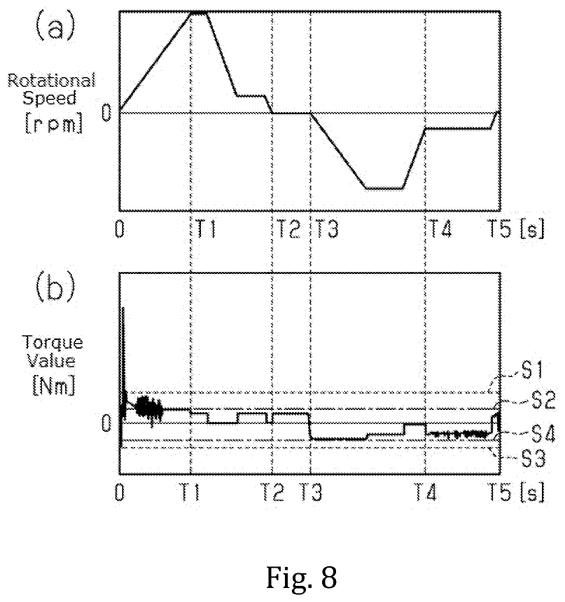

As shown in the graph (a) in FIG. 8, the door control device 30 drives and controls the drive unit 40 in the same manner for every opening-closing control. In the graph, the positive and negative values respectively denote the rotational speed during the opening control and the rotational speed during the closing control. Under a normal condition, the same period of time elapses after the opening control information is obtained for every opening control. Likewise, under a normal condition, the same period of time elapses after the closing control information is acquired for every closing control. The door control device 30 acquires the opening control information at the time 0, and performs the plugging operation by controlling the first and second door leaves 1 and 2 to move outwardly from the car body in the period from the time 0 to the time T1. Subsequently, the door control device 30 performs the opening operation in the period from the time T1 to the time T2. After this, the door control device 30 acquires the closing control information at the time T3, and performs the closing operation in the period from the time T3 to the time T4. Following this, the door control device 30 performs the plugging operation by controlling the first and second door leaves 1 and 2 to move toward the inside of the car body in the period from the time T4 to the time T5.

As shown in FIG. 6, the drive information obtaining unit 33 obtains drive information including at least one of the current value or torque value of the drive unit 40. The current value of the drive unit 40 indicates the level of the current flowing through the drive unit 40, and the torque value of the drive unit 40 indicates the torque output from the drive unit 40 to the target to be driven. In the present embodiment, the drive information obtaining unit 33 obtains the rotational speed and torque value of the drive unit 40. The diagnosing unit 34 diagnoses an abnormality in the guide rollers or guide rails based on the drive information observed in the plugging operation period identified by the identifying unit 32 based on the opening-closing control information. The diagnosing unit 34 diagnoses an abnormality in the guide rollers or guide rails by determining whether the torque value included in the drive information observed in the identified plugging operation period exceeds a threshold value. The memory unit 35 stores thereon the drive information. The memory unit 35 stores thereon how the rotational speed and torque value of the drive unit 40 vary. The generating unit 36 generates the threshold value based on the drive information stored on the memory unit 35. The generating unit 36 generates the threshold value by adding a predetermined value to the maximum value of the torque value in the operation period under a normal condition.

As shown in the graph (b) in FIG. 8, the threshold value for the plugging operation is greater than the threshold value for the opening-closing operation. In the graph, the positive and negative values respectively denote the torque value during the opening control and the torque value during the closing control. For the plugging operation during the opening control in the period from the time 0 to the time T2, a first threshold value S1 is set. For the opening operation during the opening control, a second threshold value S2 is set. The first threshold value S1 is greater than the second threshold value S2 (S1>S2). For the plugging operation during the closing control in the period from the time T3 to the time T5, a third threshold value S3 is set. For the closing operation during the closing control, a fourth threshold value S4 is set. Since the third and fourth threshold values S3 and S4 are negative values, they are compared in their absolute values. The third threshold value S3 is greater than the fourth threshold value S4 (S3>S4). In the case of plug doors, an opening control starts following a plugging operation where the guide rollers significantly touch the guide rails. For this reason, the threshold is set greater for the opening control than for the closing control. Therefore, in the case of plug doors, it is easier to diagnose an abnormality in the guide rollers or guide rails during the opening control than during the closing control.

### Procedures

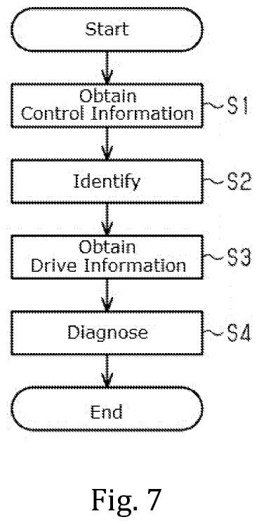

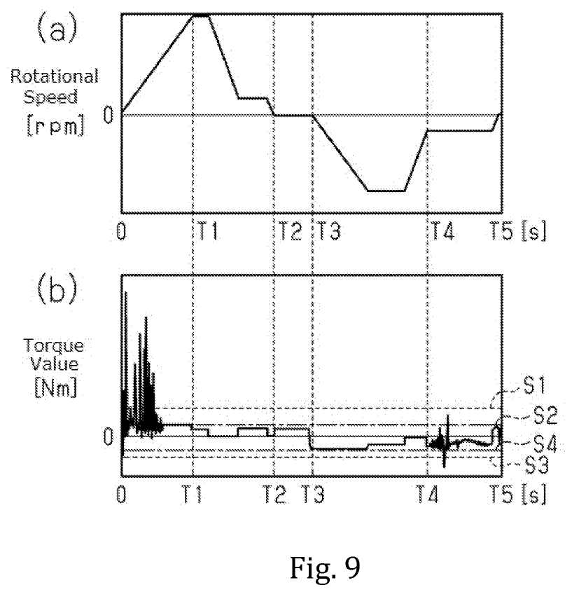

The following now describes the procedures performed by the door control device 30 described above with reference to FIGS. 7 and 9. FIG. 9 includes the graphs showing the values observed in a case where the guide rails or guide rollers experience an abnormality. The rotational speed shown in the graph (a) in FIG. 9 is the same as that shown in the graph (a) in FIG. 8. The torque value shown in the graph (b) in FIG. 9 is different from that shown in the graph (b) in FIG. 8. More specifically, the torque value shown in the graph (b) in FIG. 9 is greater than that shown in the graph (b) in FIG. 8.

The drive control unit 31 performs an opening-closing control on the drive unit 40 in response to the door control device 30 receiving an opening-closing control instruction issued by the driver's cab 5.

As shown in FIG. 7, as the drive control unit 31 starts an opening-closing control, the door control device 30 performs a control information obtaining procedure (step S1). Specifically, the identifying unit 32 obtains from the drive control unit 31 opening-closing control information, in other words, opening control information relating to a control designed to open the first and second door leaves 1 and 2 or closing control information relating to a control designed to close the first and second door leaves 1 and 2. The identifying unit 32 determines the time at which the opening-closing control starts based on the opening-closing control information.

Subsequently, the door control device 30 performs an identifying procedure (step S2). Specifically, the identifying unit 32 identifies the plugging operation period and opening-closing operation period based on the elapsed time since the time at which the opening-closing control starts, which is included in the opening-closing control information. The identifying unit 32 measures the elapsed time from the time at which the opening-closing control information is received.

Subsequently, the door control device 30 performs a drive information obtaining procedure (step S3). Specifically, the drive information obtaining unit 33 obtains the rotational speed and torque value of the drive unit 40. The drive information obtaining unit 33 preferably obtains the drive information observed during the entire period from the fully closed state to the fully opened state, or during the entire period from the fully opened state to the fully closed state, not the drive information observed during part of the period in which the opening-closing operation is performed.

Subsequently, the door control device 30 performs a diagnosing procedure (step S4). In other words, the diagnosing unit 34 diagnoses an abnormality in the guide rollers or guide rails by determining whether the torque value included in the drive information observed in the plugging operation period identified by the identifying unit 32 exceeds a threshold value.

As shown in FIG. 9, the diagnosing unit 34 diagnoses the guide rollers or guide rails as having an abnormality since the torque value exceeds the first threshold value S1 in the period from the time 0 to the time T1, where the plugging operation is performed for the opening control. The diagnosing unit 34 also diagnoses the guide rollers or guide rails as having an abnormality since the torque value exceeds the third threshold value S3 in the period from the time T4 to the time T5, where the plugging operation is performed for the closing control. Note that the torque value never exceeds the second threshold value S2 in the period from the time T1 to the time T2, where the opening operation is performed for the opening control. Likewise, the torque value never exceeds the fourth threshold value S4 in the period from the time T3 to the time T4, where the closing operation is performed for the closing control. The door control device 30 outputs an abnormality to the driver's cab 5 if the guide rollers or guide rails are diagnosed as having an abnormality. The door control device 30 may announce an abnormality using light or sound in the door opening-closing device 10. In the above-described manner, the door opening-closing device 10 completes the series of operations.

Advantageous effects of the above embodiment will be now described.

(1) The drive information observed in the period in which the plug door performs the plugging operation (the plugging operation period) identified by the identifying unit 32 is used to diagnose an abnormality in the guide rollers or guide rails. Therefore, the guide rollers or guide rails can be diagnosed as having an abnormality before they break down.

(2) Since the plugging operation period is identified based on the opening-closing control information obtained from the drive control unit 31, the plugging operation period can be reliably determined. In addition, the diagnosis can be easily made since the diagnosis only requires comparing the values included in the drive information for the plugging operation period against the threshold value.

(3) The plugging operation period is identified based on the elapsed time from the time at which the opening-closing control starts, which is included in the opening-closing control information. In the case of plug doors, the load is greater during the plugging operation than during the opening-closing operation. In light of this, the plugging operation period is identified before an abnormality can be diagnosed.

(4) The threshold value is greater for the plugging operation than for the opening-closing operation. In the case of plug doors, the load is greater during the plugging operation than during the opening-closing operation. According to the present invention, the threshold value applied for diagnosing an abnormality during the plugging operation is different from the threshold value applied for diagnosing an abnormality during the opening-closing operation.

(5) The guide rollers or guide rails are examined to diagnose an abnormality while the plug door is performing the opening operation. It is easier to diagnose an abnormality in the guide rollers or guide rails than while the plug door is performing the closing operation.

(6) The threshold value is generated based on the information stored on the memory unit 35. The threshold value used to diagnose an abnormality in the guide rollers or guide rails can be generated in light of individual differences between plug doors.

### Other Embodiments

The foregoing embodiment can be modified as described below. The above embodiment and the following modifications can be implemented in combination to the extent where they are technically consistent to each other.

According to the foregoing embodiment, the memory unit 35 stores thereon the drive information, and the generating unit 36 generates the threshold value based on the drive information stored on the memory unit 35. The present invention, however, is not limited to such. The threshold value may not be generated for each plug door, and the diagnosis may be made based on a predetermined threshold value.

According to the foregoing embodiment, the diagnosing unit 34 may diagnose an abnormality if the value included in the drive information observed during at least one of the plugging operation or the opening-closing operation exceeds the threshold value a benchmark number of times or more. Therefore, a temporarily detected abnormality can be excluded during attempts to diagnose an abnormality in the guide rollers or guide rails.

In the foregoing embodiment, the diagnosing unit 34 may diagnose an abnormality only during the plugging operation. In this case, no threshold value needs to be generated during the opening-closing operation. The generating unit 36 may not be required to generate the threshold value for the opening-closing operation.

In the foregoing embodiment, the drive information obtaining unit 33 may only obtain the drive information observed during the plugging operation. In this case, the generating unit 36 may only generate the threshold value for the plugging operation. The diagnosing unit 34 may diagnose an abnormality only for the plugging operation.

In the foregoing embodiment, the plugging operation period and opening-closing operation period are identified based on the elapsed time from the time at which the opening-closing control starts, which is included in the opening-closing control information. The present invention, however, is not limited to such. The plugging operation period and opening-closing operation period may be identified by examining how the rotational speed or other variables included in the drive information change over time. Alternatively, the plugging operation period and opening-closing operation period may be identified using a sensor such as a limit switch or an image.

In the foregoing embodiment, an abnormality is diagnosed in the guide rollers or guide rails by determining whether the value included in the drive information observed during the plugging operation period exceeds the threshold value. The present invention, however, is not limited to such. An abnormality may be diagnosed in the guide rollers or guide rails by observing a change in the value included in the drive information observed for the plugging operation.

In the foregoing embodiment, there are three third guide rollers 23A and three fourth guide rollers 24A. The numbers of the third and fourth guide rollers 23A and 24A, however, are not limited to three but may be one, two, four or more or any other number.

The foregoing embodiment may be implemented without the third and fourth guide rails 17 and 18. If such is the case, the embodiment may be implemented without the first swing arm 23, third guide rollers 23A, second swing arm 24 and fourth guide rollers 24A.

The foregoing embodiments describe a plurality of physically separate constituent parts. They may be combined into a single part, and any one of them may be divided into a plurality of physically separate constituent parts. Irrespective of whether or not the constituent parts are integrated, they are acceptable as long as they are configured to solve the problems.

According to the foregoing embodiments, a plurality of functions are distributively provided. Some or all of the functions may be integrated. Any one of the functions may be partly or entirely segmented into a plurality of functions, which are distributively provided. Irrespective of whether or not the functions are integrated or distributed, they are acceptable as long as they are configured to solve the problems.

What is claimed is:

1. A diagnosing device comprising circuitry, the circuitry being configured to perform:
identifying a plugging operation period in which a plug door performs a plugging operation, the plug door having a guide roller attached thereto, the plug door being configured to perform an opening-closing operation and the plugging operation by allowing the guide roller to move along a guide rail;
obtaining drive information including a value representing at least one of a current value or a torque value of a drive unit, the drive unit being configured to drive the plug door; and
diagnosing an abnormality in the guide roller or the guide rail based on the drive information observed during the identified plugging operation period.

2. The diagnosing device of claim 1, wherein the circuitry is configured to perform:
identifying the plugging operation period based on opening-closing control information obtained from a control unit, the control unit being configured to control the drive unit; and
diagnosing an abnormality in the guide roller or the guide rail by determining whether the value included in the drive information observed during the plugging operation period exceeds a first threshold value.

3. The diagnosing device of claim 2,
wherein the opening-closing control information includes an elapsed time from a time at which an opening control or a closing control starts, and
wherein the circuitry is configured to identify the plugging operation period based on the elapsed time.

4. The diagnosing device of claim 3, wherein the first threshold value is greater than a second threshold value set for the value included in the drive information observed during the opening-closing operation.

5. The diagnosing device of claim 4, wherein the circuitry is configured to diagnose an abnormality if the value included in the drive information observed during the plugging operation period exceeds the first threshold value a benchmark number of times or more.

6. The diagnosing device of claim 1, wherein the circuitry is configured to diagnose an abnormality in the guide roller or the guide rail based on the drive information observed during the plugging operation period during an opening control performed for the plug door.

7. The diagnosing device of claim 2, wherein the circuitry is configured to perform:
storing the drive information; and
generating the first threshold value based on the stored drive information.

8. The diagnosing device of claim 4, wherein the circuitry is configured to perform:
storing the drive information; and
generating at least one of the first threshold value or the second threshold value based on the stored drive information.

9. A diagnosing method comprising:
identifying, by circuitry a plugging operation period in which a plug door performs a plugging operation, the plug door having a guide roller attached thereto, the plug door being configured to perform an opening-closing operation and the plugging operation by allowing the guide roller to move along a guide rail;
obtaining, by the circuitry, drive information including a value representing at least one of a current value or a torque value of a drive unit, the drive unit being configured to drive the plug door; and
diagnosing, by the circuitry, an abnormality in the guide roller or the guide rail based on the drive information observed during the identified plugging operation period.

10. A non-transitory computer-readable medium storing a diagnosing program, when executed by circuitry, the diagnosing program causes the circuitry to perform:
identifying a plugging operation period in which a plug door performs a plugging operation, the plug door having a guide roller attached thereto, the plug door being configured to perform an opening-closing operation and the plugging operation by allowing the guide roller to move along a guide rail;
obtaining drive information including a value representing at least one of a current value or a torque value of a drive unit, the drive unit being configured to drive the plug door; and
diagnosing an abnormality in the guide roller or the guide rail based on the drive information observed during the identified plugging operation period.
